(19) United States
(12) Patent Application Publication
(10) Pub. No.: US 2011/0047001 A1
(43) Pub. Date: Feb. 24, 2011

(54) METHOD AND SYSTEM FOR CREATING AN INSTANCE OF AN ADAPTABLE BUSINESS OBJECT

(76) Inventors: WEN GU, Shanghai (CN); Bin Fu, Shanghai (CN); Sergio Lencinas, Wiesloch/Baiertal (DE); Jesus Lopez Mijan, Brussel (BE)

Correspondence Address: SAP AG, 3410 HILLVIEW AVENUE, PALO ALTO, CA, 94304, US

(21) Appl. No.: 12/544,224

(22) Filed: Aug. 20, 2009

(51) Int. Cl. G06Q 10/00; G06F 17/30; G06F 11/07

(52) U.S. Cl. 705/9; 705/7; 714/48; 714/E11.024; 714/E11.025; 707/E17.044

(57) ABSTRACT

Described are methods and systems related to creating an instance of an adaptable business object for a business scenario. A scenario specific action node is received to perform the business scenario. Based upon a scenario specific action node identifier of the received scenario specific action node, an adaptable business object is identified. A dimension version associate with the identified adaptable business object is determined. Based upon a dimension code of the dimension version, metadata of the dimension version is retrieved. Business logic that is operable for creating an instance of the adaptable business object for the dimension version is identified. Based upon the identified business logic, the metadata of the dimension version and the adaptable business object are compiled to create the instance of the adaptable business object for the dimension version.

### TECHNICAL FIELD

Embodiments of the invention generally relate to computer systems, and more particularly to methods and systems for data reporting and analysis.

### BACKGROUND

Enterprise content management generally relates to managing content involving digital data that may be dependent on business scenarios influenced by attributes such as industry, geography, lines of business, customers, product lines and the like. For instance, a multinational company having customers and prospects throughout the world and having a product portfolio that addresses multiple industries and branches, has to provide documentation which supports easy generation of country, industry and language specific content. The content may be marketing documents, presentations, sales pitches, cost-benefit calculations, forms, tables, files and the like. While much of the content may need to be customized to the business scenario, there is a lot of redundant content that is repeated for each of the scenarios. As a lot of redundant data is involved, the development and maintenance of content becomes wasteful. There is a need for methods and systems for reusing as much of the available content as possible and for developing the content that is specific to the business scenarios in order to minimize redundancy of development and maintenance efforts.

### SUMMARY OF THE INVENTION

Embodiments of the invention are generally directed to methods and systems for creating an instance of an adaptable business object for a business scenario. An adaptable business object may be described as a business object that may be reused under considerations of business scenarios. Thus, the adaptable business object includes business information that can be used according to business scenarios. An instance of the adaptable business object may describe a particular situation of a business scenario, having attributes associated with that situation. To perform the business scenario, a scenario specific action node is received. Based upon a scenario specific action node identifier of the received scenario specific action node, an associated adaptable business object is identified. To create an instance of the adaptable business scenario, a dimension version associated with the adaptable business object is received. A dimension code associated with the dimension version is utilized to retrieve metadata of the dimension version. The metadata of the dimension version may include information that is specific to the received dimension version. Business logic that is operable for creating the instance of the adaptable business object for the dimension version is identified. Based upon the identified business logic, the metadata of the dimension version and the adaptable business object are compiled to create the instance of the adaptable business object for the dimension version.

These and other benefits and features of embodiments of the invention will be apparent upon consideration of the following detailed description of preferred embodiments thereof, presented in connection with the following drawings in which like reference numerals are used to identify like elements throughout.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 is an exemplary block diagram illustrating a client-server system according to an embodiment of the invention.

FIG. 2 is an exemplary block diagram illustrating a client-server system utilized for creating an instance of an adaptable business object for a business scenario, according to one embodiment of the invention.

FIG. 3 is an exemplary block diagram illustrating a process for creating an instance of an adaptable business object for a business scenario, according to one embodiment of the invention.

FIG. 4 is an exemplary flow diagram illustrating a system for creating an instance of an adaptable business object for a business scenario, according to one embodiment of the invention.

FIG. 5 is an exemplary block diagram illustrating a process for creating an instance of an adaptable business object for a business scenario, according to one embodiment of the invention.

### DETAILED DESCRIPTION

Embodiments of the invention are generally directed to methods and systems for creating an instance of an adaptable business object for a business scenario. The adaptable business object is created by analyzing a scenario specific action node and a dimension version that is selected to perform the business scenario. The scenario specific action node describes an association of one or more parameters to perform the business scenario with the corresponding group of information that is necessary to perform the business scenario. The group of information may be represented as an adaptable business object. The dimension version describes a parameter based upon which an instance of the adaptable business object is created. In other words, a dimension version may be described as a factor for which the adaptable business object is customized, to perform the business scenario for the selected parameters. Based upon a selection of a scenario specific action node, a corresponding adaptable business object is identified. Based upon a selection of a dimension version for the adaptable business object, metadata of the dimension version is retrieved. The metadata of the dimension version may be described as information that is specific to the dimension version for the adaptable business object. The metadata of the dimension version and the adaptable business object is complied based upon business logic, to create an instance of the adaptable business object for the selected dimension version.

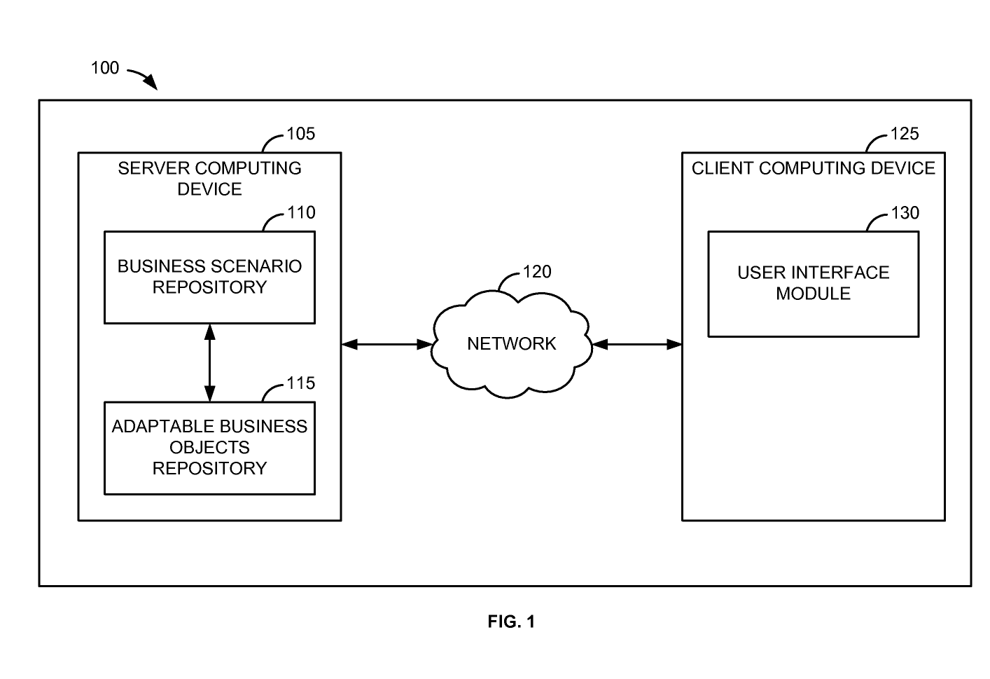

FIG. 1 is an exemplary block diagram illustrating a client-server system according to an embodiment of the invention. Block diagram 100 includes server computing device 105, business scenario repository 110, adaptable business objects repository 115, network 120, client computing device 125 and user interface module 130. Server computing device 105 receives requests or transits responses associated with business information of an enterprise infrastructure. In an embodiment, server computing device 105 may include business scenario repository 110 and adaptable business objects repository 115. Business scenario repository 110 stores one or more business scenarios. A business scenario may be described as a set of business processes that define a business task in a comprehensive manner. Adaptable business objects repository 115 stores one or more adaptable business objects. A business object is typically a collection of business information associated with a respective business scenario. An adaptable business object may be described as a business object that may be reused under various considerations of the business scenario.

Server computing device 105 may also obtain one or more streams of business information from client computing device 125. Server computing device 105 communicates with the client computing device 125 through network 120. In an embodiment, client computing device 125 includes user interface module 130. User interface module 130 may be responsible for receiving user inputs for selecting a business scenario, an adaptable business object and the like. In an embodiment, server computing device 105 may be responsible for creating an instance of one or more adaptable business objects for a business scenario selected on user interface module 130 on client computing device 125. Network 120 may include, but is not limited to, local area network (LAN), wide area network (WAN), metropolitan area network (MAN), public switched telephone network (PSTN), Bluetooth network, internet, intranet and Ethernet.

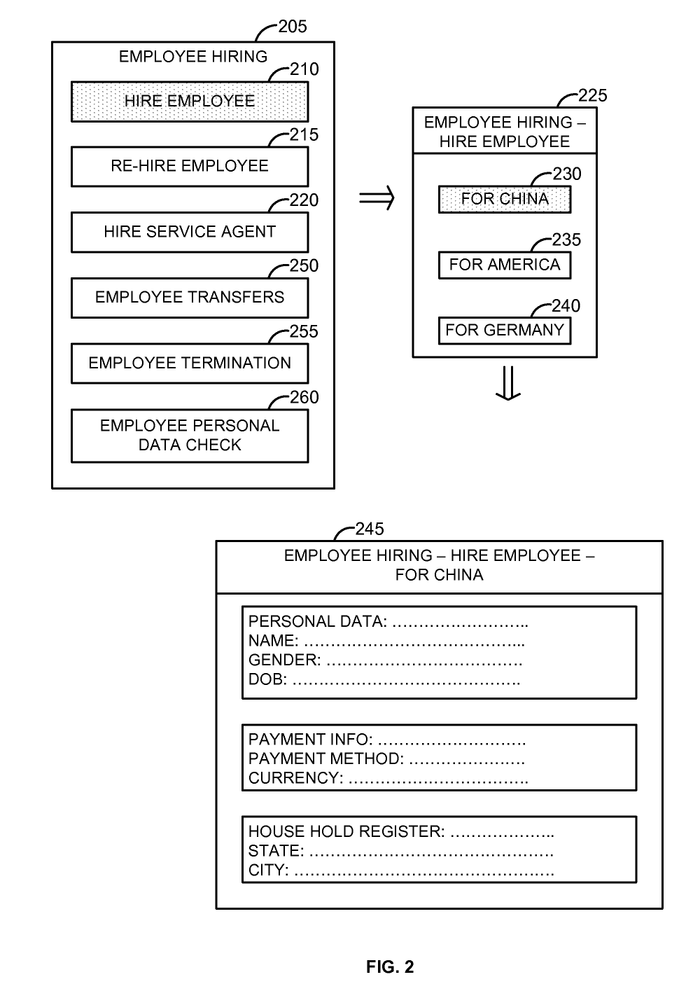

FIG. 2 is an exemplary block diagram illustrating a process for creating an instance of an adaptable business object for a business scenario, according to one embodiment of the invention. A business scenario may be described as a set of business processes that define a business task, including necessary information about the business task. An adaptable business object may be described as a business object that is reused under various considerations of the business scenario. Thus, the adaptable business object includes business information that can be used in various situations. For example, for a business scenario of hiring an employee for a company, the business object representing the attributes necessary for an employee for various positions in the company is described as an adaptable business object. The same group of business objects may thus be associated with the scenario specific action nodes for hiring an employee with finance knowledge, technical expertise, sales experience or managerial skills. Element 205 depicts a business scenario of “EMPLOYEE HIRING”, including scenario specific action nodes 210, 215, 220, 250, 255, and 260 associated with the business scenario. Each of the scenario specific action nodes may be regarded as a sub-scenario that is operable to perform a scenario specific action. A scenario specific action node may represent a link to a group of information that is necessary to perform the business scenario. Thus, the scenario specific action nodes 210, 215, 220, 250, 255 and 260 are operable to perform respective actions associated with them, for example, hire employee, re-hire employee, hire service agent, employee transfers, employee termination, and employee personal data check. Each of the scenario specific action nodes has one or more business objects associated with them. The business objects are generally reusable or adaptable under various considerations of the business scenario.

Each scenario specific action node may be associated with a scenario specific action node identifier. The scenario specific action node identifier may be described as a unique identifier of the scenario specific action node that acts as a reference for the scenario specific action node. The scenario specific action node identifier is received based upon the selection of the scenario specific action node. In an embodiment, a user selects scenario specific action node 210 “HIRE EMPLOYEE”, to perform the business scenario 205 “EMPLOYEE HIRING”. Based upon a scenario specific action node identifier of scenario specific action node 210, an adaptable business objects associated with the scenario specific action node identifier of the scenario specific action node 210 is identified. Identifying the adaptable business object involves recognizing one or more adaptable business objects associated with the selected scenario specific action node (for example 210), and rendering information included in the adaptable business object. In an embodiment, identifying the adaptable business object includes initializing the adaptable business object associated with the scenario specific action node. Initializing the adaptable business object involves triggering the adaptable business object for further execution. Element 225 represents information rendered based upon the adaptable business object associated with the scenario specific action node 210.

Element 225 includes dimension versions 230, 235 and 240 associated with it. A dimension version may represent parameters based upon which the instance of the adaptable business object is created, to perform the business scenario. Each adaptable business object may contain a group of such dimension versions, each dimension version representing a parameter for the adaptable business object. For instance, for an adaptable business object representing a geographical sales location, the dimension versions may include America, Germany, France, China, India and the like. Each dimension may be associated with a dimension code. The dimension code may be described as a unique code of the dimension version that acts as a reference for that dimension version. The dimension code is received based upon the selection of the dimension version. The user selects dimension version 230 “FOR CHINA” to create an instance of the adaptable business object. Based upon a dimension code of dimension version 230, metadata of dimension version 230 is retrieved. The metadata of dimension version 230 may include information that is specific to dimension version 230. Business logic that is operable for creating an instance of the adaptable business object for dimension version 230 is identified. Based upon the identified business block, the metadata of dimension version 230 and the adaptable business object are compiled to create instance 245 of the adaptable business object for dimension version 230. Instance 245 of the adaptable business object for dimension version 230 may include information present in the adaptable business object that is mandatory or general to all dimension versions (for example, 230, 235, 240, etc.) along with metadata of dimension version 230 that is specific to dimension version 230. Thus, instance 245 of the adaptable business object may be created for any dimension version.

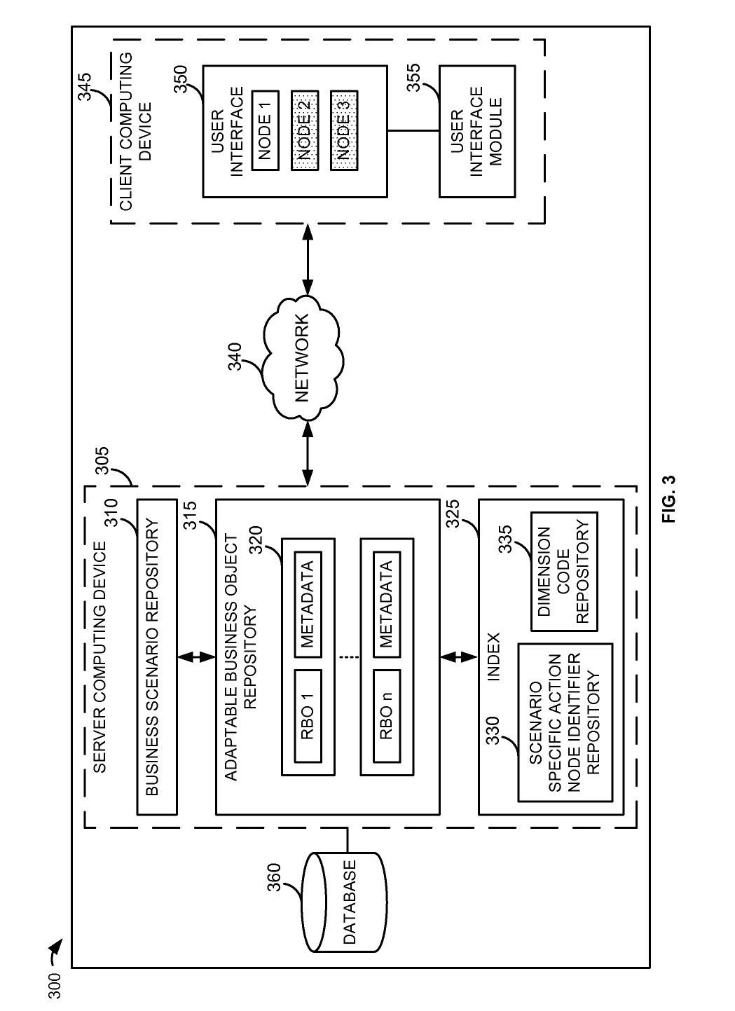

FIG. 3 is an exemplary block diagram illustrating a client-server system utilized for creating an instance of an adaptable business object for a business scenario, according to one embodiment of the invention. Business scenario repository 310 may be utilized to store one or more business scenarios. The adaptable business objects may be stored in adaptable business object repository 315. Element 320 represents an adaptable business object RBO1 including associated metadata of the adaptable business object RBO1. An instance of the adaptable business object may describe a particular situation of the business scenario, having attributes associated with that situation. For example, an instance of the business scenario of hiring an employee may be hiring an employee with marketing skills. In an embodiment, server computing device 305 hosts business scenario repository 310 and adaptable business object repository 315.

To perform the business scenario, a scenario specific action node of the business scenario is selected. Scenario specific action node identifier repository 330 may store the scenario specific action node identifiers of one or more scenario specific action nodes available for the business scenario. Based upon the scenario specific action node identifier of the scenario specific action node, an associated adaptable business object is identified. The associated adaptable business object (for example, RBO1) may be residing in adaptable business object repository 315. Adaptable business object repository 315 accepts the scenario specific action node identifier of the scenario specific action node, and identifies one or more of the adaptable business objects associated with the scenario specific action node identifier of the scenario specific action node. In an embodiment, adaptable business object repository 315 deciphers the scenario specific action node identifier of the scenario specific action node to identify one or more adaptable business objects associated with the scenario specific action node identifier. Adaptable business object repository 315 may be searched, to retrieve one or more adaptable business objects associated with the scenario specific action node identifier.

In an embodiment, adaptable business object repository 315 may be searched to identify mandatory information that is necessary for the associated scenario specific action node identifier. The mandatory information may be set as global information that will be associated with all the scenario specific action node identifiers, irrespective of the adaptable business objects associated with them. In an embodiment, the adaptable business objects may share a mapping with one or more associated scenario specific action node identifiers. Based upon the mapping that exists between the scenario specific action node and one or more adaptable business objects, the adaptable business objects necessary to perform the business scenario is identified.

To create an instance of the adaptable business scenario, a dimension version associated with the identified adaptable business object is received. In an embodiment, a user selects a dimension version. A dimension version may represent parameters based upon which the instance of the adaptable business object is created, to perform the business scenario. Each adaptable business object may contain a group of such dimension versions, each dimension version representing a parameter for the adaptable business object. For instance, for an adaptable business object representing a geographical sales location, the dimension versions may include America, Germany, France, China, India and the like. Each dimension may be associated with a dimension code. The dimension code may be described as a unique code of the dimension version that acts as a reference for that dimension version. The dimension code is received based upon the selection of the dimension version. Dimension code repository 335 may store the dimension codes of one or more dimension versions associated with the identified adaptable business object. Based upon the dimension code of the selected dimension version, metadata associated with the dimension version is retrieved. The metadata of the dimension version may include information that is specific to the selected dimension version. This information may be utilized to create an instance of the adaptable business object, thereby customizing the adaptable business object to the dimension version selected. For example, consider a user selection of a dimension version “For China” for the scenario specific action node “Hire Employee” for a business scenario “Employee Hiring”. Metadata of the dimension version “For China” may include information specific to China, for instance, currency details, tax details, payment mode, regulations according to China's labor law, and the like. This information is utilized to create an instance of the adaptable business object for the dimension version “For China”, thereby customizing the adaptable business object to China.

In an embodiment, index 325 hosts scenario specific action node identifier repository 330 and dimension code repository 335. Client computing device 345 includes user interface 350 and user interface module 355. User interface 350 is operable for receiving a user selection of a scenario specific action node for a business scenario. The scenario specific action node received as a user selection is identified by user interface module 355 and communicated to server computing device 305 via network 340. Index 325 determines a corresponding scenario specific action node identifier for the selected scenario specific action node from scenario specific action node identifier repository 330. Further, index 325 identifies an adaptable business object hosted in adaptable business object repository 315 that is associated with the scenario specific action node identifier of the scenario specific action node, and identifies the adaptable business object associated with the scenario specific action node.

One or more dimension versions associated with the identified adaptable business object are rendered on the user interface 350. The dimension versions of the identified adaptable business object may be retrieved from the metadata of the corresponding adaptable business object. User interface 350 receives a selection of a dimension version for the business scenario. The received dimension version is identified by user interface module 355 and communicated to server computing device 305 via network 340. Index 325 determines a corresponding dimension code for the selected dimension version from dimension code repository 335. Based upon the dimension code of the selected dimension version, index 325 retrieves metadata associated with the selected dimension version. Metadata for the received dimension version of the identified adaptable business object may include information that is specific to the corresponding adaptable business object. In an embodiment, such metadata of the adaptable business object may be contained along with the adaptable business object in element 320.

Business logic that is operable for creating the instance of the adaptable business object for the dimension version is identified. The business logic may be described as a generic interface that is associated with the adaptable business object. Once the adaptable business object is identified, the business logic associated with the adaptable business object may be utilized to configure an instance of the adaptable business object. Based upon the identified business logic, the metadata for the dimension version and the adaptable business object are compiled to create the instance of the adaptable business object for the dimension version.

In an embodiment, the metadata of the adaptable business objects in adaptable business object repository 315 may be updated based upon a user input. Index 325 may update scenario specific action node identifier repository 330 and dimension code repository 335, based upon the user input. In an embodiment, index 325 may be utilized for error detection, to determine a consistency and/or a compatibility that may exist between one or more of the adaptable business objects. The error detection may be initialized during the configuration of an instance of the adaptable business object. The consistency/compatibility of the adaptable business objects may be described as a feature that allows an association to exist between two or more adaptable business objects. For instance, a feature may exist that allows utilization of metadata of a first adaptable business object by a second adaptable business object. During such utilizations, the metadata of the second adaptable business object has to be checked for compatibility with the metadata of the first adaptable business object. An error may be detected if the second adaptable business object is not compatible with the first adaptable business object. This error detection may be sent as an alert to the user, to prompt the user to select a different adaptable business object.

In an embodiment, based upon the metadata retrieved for the dimensions version of the adaptable business object, a task list may be compiled. The task list may include one or more tasks that may have to be accomplished, to create the instance of the adaptable business object for the received dimension version. For instance, when a particular business scenario “Employee Hiring” is initiated for a particular scenario specific action node “hiring”, a scenario specific action node identifier “12345” of the scenario specific action node “hiring” is retrieved. Based upon the scenario specific action node identifier “12345”, one or more associated dimension versions are rendered. Based upon a selection of a dimension version “China”, metadata associated with the dimension version “China” is retrieved. This metadata includes information about the dimension version “China”. Based upon the metadata, a task list that includes a group of one or more tasks may be complied. The task list may include China specific personal identification of an employee, payroll of the employee that is specific to China, tax details of China, employment contract under the laws of China, and the like, that are necessary to create an instance of an adaptable business object for the scenario specific action node “hiring” and the dimension version “China”.

Thus, the adaptable business object associated with the scenario specific action node “hiring” is customized for the selected dimension version “China”, without creating a unique adaptable business object for each dimension versions (for example, hiring, terminating, re-hiring, and the like). The instance of the adaptable business object represents one such customized version of the adaptable business object for the selected dimension version.

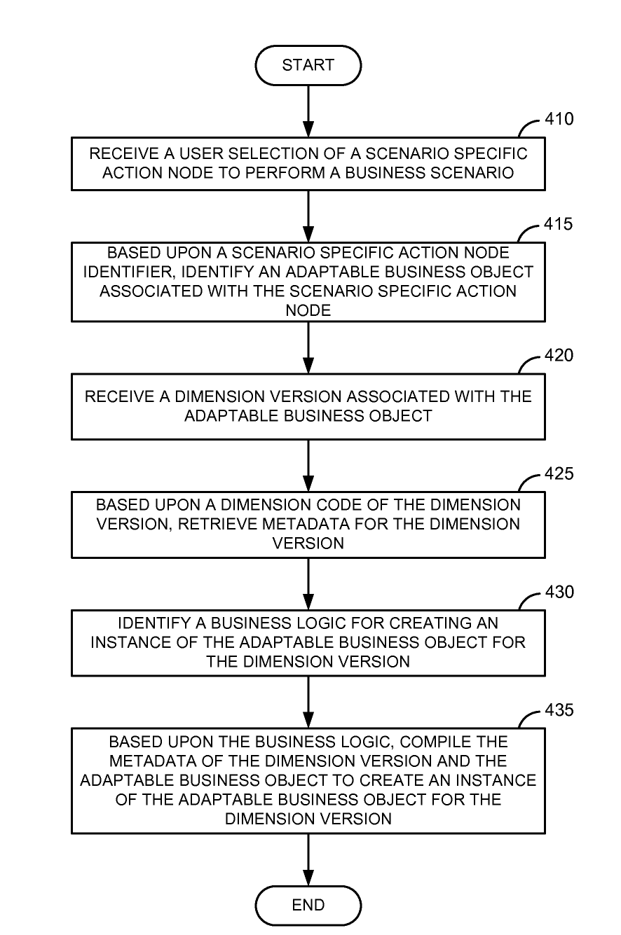

FIG. 4 is a flow diagram of an exemplary process for creating an instance of an adaptable business object for a business scenario, according to one embodiment of the invention. In process block 410, a scenario specific action node is received for performing the business scenario. In process block 415, based upon a scenario specific action node identifier of the received scenario specific action node, an adaptable business object is identified for the business scenario. In process 420, a dimension version associated with the adaptable business scenario is received. In process block 425, based upon a dimension code of the dimension version, metadata for the dimension version is retrieved. In process block 430, business logic operable for creating an instance of the adaptable business object for the dimension version is identified. In process block 435, based upon the identified business logic, the metadata of the dimension version and the adaptable business object is compiled, to create the instance of the adaptable business object for the dimension version.

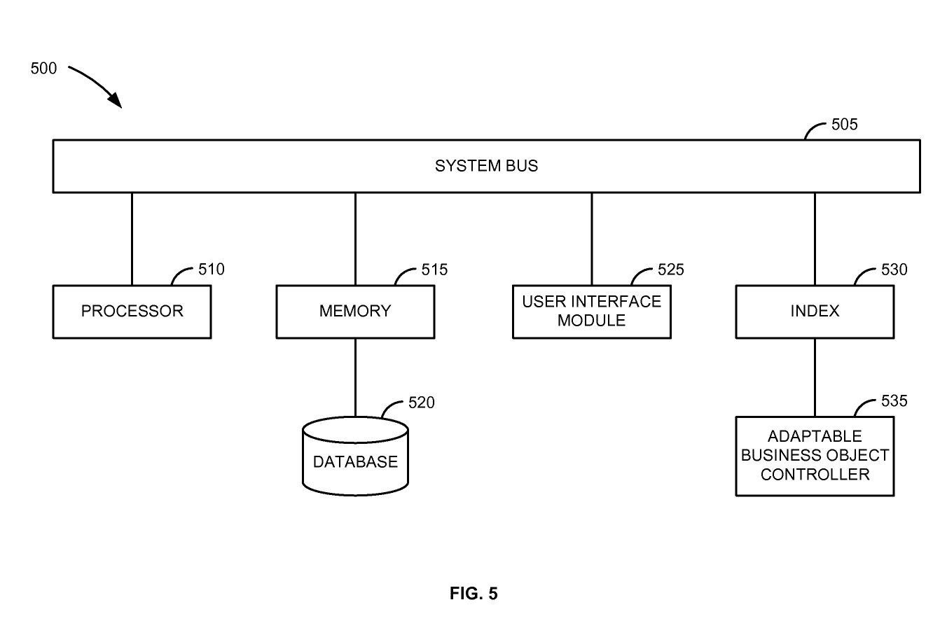

FIG. 5 is an exemplary block diagram illustrating a system for creating an instance of an adaptable business object for a business scenario, according to one embodiment of the invention. System 500 includes system bus 505, processor 510, memory 515, database 520, user interface module 525, index 530 and adaptable business object controller 535. System bus 505 establishes necessary communication between the elements of system 500. Processor 510 is operable for reading and executing instructions stored in memory elements (for example memory 515). The memory elements may be stored in database 520. Database 520 may also store one or more business scenarios, corresponding adaptable business objects for each business scenario, metadata of the adaptable business objects, and the like.

To perform the business scenario, user interface module 525 is utilized for receiving a selection of a scenario specific action node and a selection of a dimension version. In an embodiment, a user may select the scenario specific action node to perform a corresponding action for the business scenario. Index 530 is responsible for identifying the adaptable business object based upon a scenario specific action node identifier of the scenario specific action node. To identify the adaptable business object associated with the scenario specific action node identifier of the scenario specific action node, index 530 may retrieve the scenario specific action node identifier for the scenario specific action node and decipher the scenario specific action node identifier to identify the appropriate adaptable business object that has to be identified. In an embodiment, a user may select a dimension version to create an instance of the identified adaptable business object.

Index 530 retrieves metadata for the selected dimension version based upon a dimension code of the dimension version. The dimension code of the dimension version may act as a reference to index 530, to retrieve the corresponding metadata associated with the dimension code of the selected dimension version. In an embodiment, index 530 is responsible to create a task list based upon the metadata of the dimension version. The task list includes one or more tasks that have to be accomplished to create the instance of the adaptable business object for the received dimension version. The task list may include mandatory tasks that have to be executed, to create the instance of the adaptable business object. In an embodiment, index 530 detects an error based upon a comparison of one or more adaptable business objects. To detect the error, index 530 identifies a compatibility that may exist between the adaptable business objects.

Adaptable business object controller 535 is responsible for identifying business logic to create an instance of the adaptable business object for the selected dimension version. In an embodiment, based upon the compatibility that exists between the adaptable business objects, the business logic is identified. To identify the business logic for creating an instance of the adaptable business object, adaptable business object controller 535 establishes an interface with the adaptable business object. Based upon the business logic, adaptable business object controller 535 compiles the metadata for the dimension version and the adaptable business object to create the instance of the adaptable business object controller, for the selected dimension version. The instance of the adaptable business object represents a customized version of the adaptable business object for the selected dimension version.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or other type of machine-readable media suitable for tangibly storing electronic instructions. For example, the invention may be implemented as a method performed in a client-server network with the execution the methods distributed across the network.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. For instance, the detailed description as set forth above includes descriptions of method steps. However, one skilled in the art will understand that the order of the steps set forth above is meant for the purposes of illustration only and the claimed invention is not meant to be limited only to the specific order in which the steps are set forth. Accordingly, the scope and spirit of the invention should be judged in terms of the claims, which follow.

What is claimed is:

1. An article of manufacture, comprising: a machine-accessible medium comprising instructions that, when executed by a machine, cause the machine to perform operations comprising:
receiving a user selection of a scenario specific action node to perform a business scenario;
based upon a scenario specific action node identifier of the scenario specific action node, identifying an adaptable business object for the business scenario associated with the scenario specific action node;
based upon a dimension code of a received dimension version associated with the adaptable business object, retrieving metadata for the received dimension version;
identifying business logic operable for creating an instance of the adaptable business object for the received dimension version; and
based upon the identified business logic, compiling the metadata for the received dimension version and the adaptable business object and creating the instance of the adaptable business object for the received dimension version.

2. The article of manufacture of claim 1, wherein the dimension version associated with the identified adaptable business object is received by a user.

3. The article of manufacture of claim 1, wherein the adaptable business object comprises metadata of one or more dimension versions.

4. The article of manufacture of claim 1, wherein identifying the adaptable business object further comprises:
receiving the scenario specific action node identifier for the received scenario specific action node; and
deciphering the scenario specific action node identifier of the received scenario specific action node to identify an adaptable business object associated with the scenario specific action node identifier.

5. The article of manufacture of claim 1, wherein identifying the business logic further comprises establishing an interface with the adaptable business object, to create the instance of the adaptable business object.

6. The article of manufacture of claim 1, wherein the created instance of the adaptable business object is stored as a template.

7. The article of manufacture of claim 1 further comprises compiling a task list based upon the metadata for the dimension version, the task list including one or more tasks to be accomplished to create the instance of the adaptable business object for the received dimension version.

8. The article of manufacture of claim 1 further comprises detecting an error based upon a comparison of one or more adaptable business objects.

9. The article if manufacture of claim 8, wherein detecting the error comprises identifying a compatibility between one or more adaptable business objects.

10. The article of manufacture of claim 9, wherein based upon identifying the compatibility between the adaptable business objects, generating an alert to report an error in the compatibility.

11. A computing device operable for creating an instance of an adaptable business object to perform a business scenario, comprising:
a processor operable for reading and executing instructions stored in one or more memory elements; and
the one or more memory elements storing instructions for:
a user interface module operable for receiving a selection of a scenario specific action node and a selection of a dimension version to perform a business scenario;
an index operable for identifying an adaptable business object based upon a scenario specific action node identifier of the scenario specific action node, and for retrieving metadata for the dimension version based upon a dimension code of the dimension version; and
an adaptable business object controller operable for identifying business logic and for compiling the metadata for the dimension version and the adaptable business object to create an instance of the adaptable business object controller.

12. The computing device of claim 11, wherein the adaptable business object controller establishes an interface with the adaptable business object, to create the instance of the adaptable business object.

13. The computing device of claim 11, wherein the index is operable to create a task list based upon the metadata of the dimension version, the task list including one or more tasks to be accomplished to create the instance of the adaptable business object for the received dimension version.

14. The computing device of claim 11, wherein the index is operable for detecting an error based upon a comparison of one or more adaptable business objects.

15. The computing device of claim 14, wherein the index identifies a compatibility between one or more adaptable business objects to detect the error.

16. The computing device of claim 14, wherein the index generates an alert to report the error detected.

17. A computer implemented method for creating an instance of an adaptable business object to perform a business scenario, the method comprising:
receiving a user selection of a scenario specific action node to perform the business scenario;
based upon a scenario specific action node identifier of the scenario specific action node, identifying an adaptable business object for the business scenario by identifying the adaptable business object associated with the scenario specific action node;
based upon a dimension code of a received dimension version associated with the identified adaptable business object, retrieving metadata for the received dimension version;
identifying business logic operable for creating the instance of the adaptable business object for the received dimension version; and
based upon the identified business logic, compiling the metadata for the received dimension version and the adaptable business object and creating the instance of the adaptable business object for the received dimension version.
